(19) United States
(12) Patent Application Publication
(10) Pub. No.: US 2023/0273095 A1
(43) Pub. Date: Aug. 31, 2023

(54) Successive Gas Path Fault Diagnosis Method with High Precision for Gas Turbine Engines

(71) Applicant: Northwestern Polytechnical University, Xi'an (CN)

(72) Inventors: Yuzhi Chen, Xi'an (CN); Zongyao Liu, Xi'an (CN); Weigang Zhang, Xi'an (CN); Linjun Lu, Xi'an (CN); Yibo Wei, Xi'an (CN)

(21) Appl. No.: 18/312,036

(22) Filed: May 4, 2023

(30) Foreign Application Priority Data
May 13, 2022 (CN) 2022105222008

(51) Int. Cl. G01M 15/05; F01D 21/00

(52) U.S. Cl. CPC G01M 15/05; F01D 21/003; F05D 2260/80; F05D 2200/10

(57) ABSTRACT

The present disclosure provides a successive gas path fault diagnosis method with high precision for gas turbine engines and falls within the technical field of fault diagnosis for gas turbine engines, including the following steps: establishing an engine nonlinear component-level model; capturing dynamic effects of an engine transient maneuver; outputting an estimated value of an engine observation parameter by the engine nonlinear component-level model; acquiring a measurement of the engine observation parameter through sensors; and iteratively updating a degradation factor through a solver. The present disclosure captures the dynamic effects of the transient maneuver at consecutive moments through time-series gas path measurement parameters, thereby realizing successive and high-precision diagnosis for health conditions of the gas turbine engines. This technology can provide a new successive and high-precision diagnosis method for the gas turbine engines under steady-state and transient conditions.

### TECHNICAL FIELD

The present disclosure falls within the technical field of fault diagnosis for gas turbine engines, and specifically relates to a successive gas path fault diagnosis method with high precision for gas turbine engines.

### BACKGROUND OF THE DISCLOSURE

In recent years, there has been a growing interest in gas path fault diagnosis for gas turbine engines. The gas path fault diagnosis is crucial to ensuring the safety, economy, and reliability of gas turbine engine operations. Since the dynamic effects in a transient maneuver have a significant impact on the precision of fault diagnosis during the transient maneuver and are difficult to determine accurately. Currently, most researchers focus on fault diagnosis at steady-state conditions. However, steady-state gas path fault diagnosis cannot realize successive diagnoses the health conditions of the gas turbine engines. Furthermore, engineering practice has been able to record and store monitoring data of the gas turbine engines in a whole working process, whereas basic theoretical researches for the gas path fault diagnosis in the transient maneuver lag behind, resulting in that a lot of transient monitoring data during flight cannot be effectively used. However, the dynamic effects in the transient maneuver of the gas turbine engines seriously affect the precision of fault diagnosis. Therefore, existing online gas path fault diagnosis for the gas turbine engines are mainly based on gas path parameters of the steady-state operating conditions at a cruise phase, and cannot meet the requirements of successive monitoring for engine health conditions during flight. However, the engine may encounter sudden failures in the transient maneuvers such as take-off and climbing and an existing steady-state gas path fault diagnosis system will delay the diagnosis of the health conditions. Hence, it is necessary to explore dynamic effects influence rules in the transient maneuver, so as to realize successive and high-precision diagnosis for the gas path faults and improve the emergency response capability of the gas turbine engines. The successive and high-precision diagnosis for the gas path faults under transient operating conditions of the gas turbine engines is a problem to be urgently solved. Therefore, with respect to health monitoring of the gas turbine engines, it is crucial to provide a fault diagnosis algorithm capable of successively capturing actual health states, especially a method that can also accurately capture the health states even if the sudden failures occur under the transient operating conditions.

### SUMMARY OF THE DISCLOSURE

### Technical Problem to be Solved

To avoid defects existing in the prior art, the present disclosure provides a successive gas path fault diagnosis method with high precision for gas turbine engines, and fault diagnosis captures the dynamic effects in a transient maneuver of the gas turbine engine according to time-series gas path measurement parameters to support successive and high-precision diagnosis for the gas path faults; and the limitation in the prior art that successive and high-precision diagnosis for engine health conditions cannot be realized is overcome.

A technical solution of the present disclosure is: a successive gas path fault diagnosis method with high precision for gas turbine engines, the gas path faults including steady-state and transient gas path faults, where the method includes the following specific steps:

Step 1: establishing an engine nonlinear component-level model;

Step 2: capturing the dynamic effects of an engine transient maneuver in the engine nonlinear component-level model;

Step 3: outputting an estimated value of an engine observation parameter by the engine nonlinear component-level model;

Step 4: acquiring a measurement of the engine observation parameter through sensors; and

Step 5: updating a degradation factor X through a solver, thereby minimizing difference between a predicated value Z_{predict} of the observation parameter outputted by a fault diagnosis model and an actual measurement Z_{Actual} of the engine observation parameter obtained by the sensors on-wing,

Z_{predict}−Z_{Actual}=f(X) (1)

where X is a degradation factor for simulating the performance degradation of engine components.

A further technical solution of the present disclosure is that: in step 1, a Newton-Raphson iterative method is used for iterating the engine nonlinear component-level model.

A further technical solution of the present disclosure is that: in step 2, a method for capturing the dynamic effects of an engine transient maneuver in the engine nonlinear component-level model includes:

(1) obtaining a rotor speed at adjacent moments based on continuous data to further obtain a rotor acceleration rate, and obtaining surplus power at any moment by the rotor acceleration rate, a rotational inertia and a rotational speed, where when considering the surplus power, turbine work is identically equal to compressor work plus the surplus power and power offtake of other auxiliary equipment, so as to update constraint conditions of fault diagnosis;

(2) obtaining a gas temperature and an engine metal temperature after considering a heat soakage effect based on the engine metal temperature Tₘ at the previous moment; and

(3) considering a lag response of the sensors and an actuator based on a first-order lag theory.

A further technical solution of the present disclosure is that: specific method steps for considering the surplus power are as follows:

as an engine shaft rotational speed is monitored in time-series, deriving the rotor acceleration rate through the deviation of the shaft rotational speed in finite time by Equation (2),

$$\frac{dN}{dt} = \frac{N ( t + Δ t ) - N ( t )}{Δ t} ) \qquad ( 2 )$$

in such a condition, calculating the surplus power (SP) by Equation (3) by the rotor acceleration rate, the shaft rotational speed and shaft inertia I:

$$S P = \frac{4 {π}^{2}}{3600} \cdot I \cdot N \cdot \frac{dN}{dt} \qquad ( 3 )$$

then, obtaining shaft power balance among all shafts by Equation (4), the equation being tenable for both steady-state and transient conditions, where SP is zero under the steady-state condition; and therefore, the conditions of the shaft power balance is met when the surplus power is considered for both the steady-state and transient conditions,

TW=SP+CW+AW (4)

where TW is turbine work, CW is compressor work, and AW is auxiliary work for power offtake.

A further technical solution of the present disclosure is that: a specific method step for considering the heat soakage is as follows:

obtaining heat transfer between gas flow and an engine metal by Equation (5),

Q=Uₕₜ·Aₕₜ(T_{g}−Tₘ)·(e^{-Δt/τ}−1) (5)

where Q is a heat rate, Uₕₜ is a heat transfer coefficient, Aₕₜ is an effective contact surface, T_{g} is a gas temperature in the current step, Tₘ is a metal temperature in the previous step, Δt is a time step, and τ is a time constant.

Add a heat transfer formula

A further technical solution of the present disclosure is that: a specific method step for considering lag response is as follows:

representing a lag response phenomenon existing in the engine sensors and the actuator during transient operation by employing a first-order lag,

$$\frac{Y ( s )}{B ( s )} = \frac{1}{τ \cdot s + 1} \qquad ( 6 )$$

where τ is a time constant, Y(s) is an input value with delay, and B(s) is an input value without delay.

A further technical solution of the present disclosure is that: in step 4, the sensors are located on wings.

A further technical solution of the present disclosure is that: in step 5, the Newton-Raphson method is selected to establish an iterative solver.

A further technical solution of the present disclosure is that: in step 5, performance simulation and fault diagnosis processes are called in the same iterative loop:

(1) characterizing the degree of degradation of each characteristic parameter in the components, i.e. the degradation factor X, by using the ratio of component characteristic parameters after degradation to component characteristic parameters in a health state;

(2) obtaining a flight altitude, a Mach number, and inlet conditions of a fan through the sensors in step 4;

(3) in the engine nonlinear component-level model of step 1, classifying convergence criteria into two categories according to an engine principle and an thermodynamics relationship of all the components: obtaining one set of convergence criteria from gas path measurements, including T₄, T₅, T₉, and T₁₀, and measurements and predicated values meeting threshold conditions; and the other set of convergence criteria being required to meet flow balance, shaft power balance, and a nozzle area design value at a design point; and

(4) in an iterative process, selecting a root mean square error RAISE defined by Equation (7) to evaluate the convergence with a threshold of 1E-5:

$$R M S E = \frac{{Z}_{Predict} - {Z}_{Actual}}{{Z}_{Actual}} . \qquad ( 7 )$$

### Beneficial Effects

The present disclosure has the following beneficial effects: the present disclosure provides a successive and high-precision diagnosis method for steady-state and transient gas path faults of a gas turbine engine, which captures the dynamic effects of a transient maneuver at consecutive moments through time-series gas path measurement parameters, where measurements are related with time, and surplus power, gas and a transient heat soakage effect and a lag response of an engine metal can be considered in successive time steps. Furthermore, successive and high-precision diagnosis of health conditions of the gas turbine engine is realized. This technology can provide a new successive and high-precision diagnosis method for the gas turbine engines under steady-state and transient conditions. This method is applicable to industrial gas turbines, turbojet engines, turbofan engines, turboprop engines, etc.

The method proposed by the present disclosure considers the surplus power, the heat soakage effect, and the lag response, and can successively diagnose the degree of engine faults in a high-precision manner under transient operating conditions. The proposed method can diagnose sudden failures during a transient maneuver within 0.1582 s at a maximum relative error of 0.0059%. Therefore, the present disclosure can realize the successive and high-precision diagnosis of the gas path faults of the gas turbine engine under both steady-state and transient conditions.

The present disclosure supplements studies on gas path fault diagnosis for gas turbine engines under the transient operating conditions, helps us to understand the gas path fault diagnosis for the gas turbine engines in various ways, improves an online health monitoring capability for the gas turbine engines, and is beneficial to the safety, availability, and reliability of the gas turbine engines, thereby providing theoretical and technical supports for the construction of safe operation guarantee capabilities for the gas turbine engines.

On the basis of the description in the examples, an average diagnosis error of the method proposed by the present disclosure is 0.0009%, which is better than that of a benchmark method.

### BRIEF DESCRIPTION OF DRAWINGS

FIG. 1 shows involved turbofan engine components and cross section numberings thereof.

FIG. 2 is a schematic diagram of a benchmark fault diagnosis method.

FIG. 3 is a schematic diagram of successive diagnosis for gas path faults based on time-series data.

FIG. 4 is a schematic diagram of a successive and high-precision diagnosis method for steady-state and transient gas path faults of a gas turbine engine.

FIG. 5 shows a fuel schedule and surplus power between compressor work and turbine work in a transient maneuver.

FIG. 6 shows estimated values of engine health parameters in a transient maneuver.

FIG. 7 shows average relative errors of health parameters in a transient maneuver.

FIG. 8 shows an effect of a heat soakage effect on exhaust gas temperature.

FIG. 9 shows estimated values of engine health parameters in a transient maneuver.

FIG. 10 shows average relative errors of health parameters in a transient maneuver.

FIG. 11 shows relative errors of health parameters in a transient maneuver.

FIG. 12 shows comparison of fault diagnosis precision of three cases.

FIG. 13 shows relative errors of health parameters in a transient maneuver.

FIG. 14 shows comparison of fault diagnosis precision of four computation examples.

FIG. 15 is a flowchart of a successive gas path fault diagnosis method with high precision for gas turbine engines.

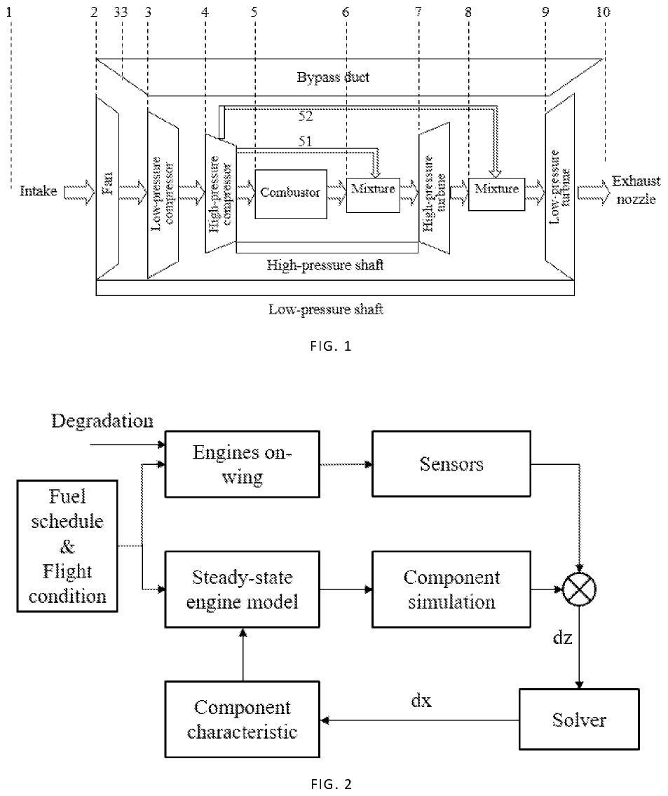

### DETAILED DESCRIPTION OF THE DISCLOSURE

The examples described below with reference to the accompanying drawings are illustrative, which are merely intended to explain the present disclosure, rather than to limit the present disclosure.

This example provides a successive and high-precision diagnosis method for steady-state and transient gas path faults of a gas turbine engine, including the following steps:

Step S1: establishing an engine nonlinear component-level model by using a Newton-Raphson iterative method;

Step S2: capturing dynamic effects of an engine transient maneuver in the model through the following three methods: (a) obtaining a rotor speed at adjacent moments based on continuous data to further obtain a rotor acceleration rate, and obtaining surplus power at any moment by the rotor acceleration rate, a rotational inertia and a rotating speed, where when considering the surplus power, turbine work is identically equal to compressor work plus the surplus power and auxiliary work for power offtake, so as to update constraint conditions of fault diagnosis; (b) obtaining a gas temperature and an engine metal temperature after considering a heat soakage effect based on the engine metal temperature (Tₘ) at the previous moment; and (c) considering a lag response of sensors and an actuator based on a first-order lag theory; and in the method proposed by the present disclosure, measurements are related with time, and the surplus power, gas and transient heat soakage effect and lag response of the engine metal can be considered in successive time steps;

Step S3: Outputting an estimated value of an engine observation parameter by the model;

Step S4: Acquiring a measurement of the engine observation parameter by the sensors located on wings; and

Step S5: Selecting the Newton-Raphson method to establish an iterative solver and update a degradation factor X, thereby minimizing difference between a predicated value Z_{predict} of the observation parameter outputted by a fault diagnosis model and an actual measurement Z_{Actual} of the engine observation parameter obtained by the sensors on-wing,

Z_{predict}−Z_{Actual}=f(X) (1)

X is a degradation factor for simulating the performance degradation of engine components.

Further, step S2 includes:

Step S21: as an engine shaft rotational speed is monitored in time-series, deriving the rotor acceleration rate through the deviation of the shaft rotational speed in finite time by Equation (2),

$$\frac{dN}{dt} = \frac{N ( t + Δ t ) - N ( t )}{Δ t} \qquad ( 2 )$$

in such a condition, calculating the surplus power (SP) by Equation (3) by the rotor acceleration rate, the shaft rotational speed and a shaft inertia (1),

$$SP = \frac{4 {π}^{2}}{3600} \cdot I \cdot N \cdot \frac{dN}{dt} \qquad ( 3 )$$

then, obtaining shaft power balance among all shafts by Equation (4), where this equation is tenable for both steady-state and transient conditions, where SP is zero under the steady-state condition; and therefore, the proposed method can meet the conditions of the shaft power balance all the time when the surplus power is considered for both the steady-state and transient conditions,

TW=SP+CW+AW (4)

where TW is turbine work, CW is compressor work, and AW is auxiliary work for power offtake;

Step S22: during transient operation, the change of gas temperature in the gas turbine engine will affect the temperature of then engine metal; this phenomenon is called the heat soakage; and the method of the present disclosure considers the heat soakage in the successive diagnosis of gas path faults at any moment in the transient maneuver of the gas turbine engine, obtaining the heat transfer between gas flow and the engine metal by Equation (5),

Q=Uₕₜ·Aₕₜ(T_{g}−Tₘ)·(e^{-Δt/τ}−1) (5)

where Q is a heat rate, Uₕₜ is a heat transfer coefficient, Aₕₜ is an effective contact surface, T_{g} is a gas temperature in the current step, Tₘ is a metal temperature in the previous step, Δt is a time step, and τ is a time constant; and

Step S23: representing a lag response existing in the engine sensors and the actuator during the transient operation by using a first-order lag,

$$\frac{Y ( s )}{B ( s )} = \frac{1}{τ \cdot s + 1} \qquad ( 6 )$$

where τ is a time constant, Y(s) is an input value with delay, and B(s) is an input value without delay.

Further, step S5 includes:

performance simulation and fault diagnosis processes are called in the same iterative loop, but are not nested iterations,

Step S51: characterizing the degree of degradation of each characteristic parameter in the components, i.e. the degradation factor X, by using the ratio of component characteristic parameters after degradation to component characteristic parameters in a health state;

Step S52: obtaining a flight altitude, a Mach number, and inlet conditions of a fan through the sensors in step S3;

Step S53: in the engine model of step S1, obtaining gas inlet conditions of the fan through an intake, and classifying convergence criteria into two categories according to an engine principle and an thermodynamics relationship of all the components: obtaining one set of convergence criteria from gas path measurements, including T₄, T₅, T₉, and T₁₀, and measurements and predicated values meeting threshold conditions; and the other set of convergence criteria being required to meet flow balance, shaft power balance, and a nozzle area design value at a design point; and

Step S54: in an iterative process, selecting a root mean square error (RMSE) defined by Equation (7) to evaluate the convergence with a threshold of 0.00001 of 1E-5 scientific notation,

$$R M S E = \frac{{Z}_{Predict} - {Z}_{Actual}}{{Z}_{Actual}} . \qquad ( 7 )$$

To enable a person skilled in the art to better understand the technical solution of the present disclosure, the present disclosure will be described in detail below with reference to the specific implementations.

The implementations of the present disclosure take fault diagnosis of gas path components of a certain type of a high bypass ratio turbofan engine as an example, where an actual turbofan engine is replaced with the nonlinear component-level model; and an iterative method of this component-level model is the Newton-Raphson method.

The turbofan engine structure and the cross section numberings thereof as shown in FIG.

1 include an intake, a fan, a low-pressure compressor, a high-pressure compressor, a combustor, a mixture model for gas bled by the high-pressure compressor, a high-pressure turbine, a low-pressure turbine, and an exhaust nozzle.

Design parameters of the turbofan engine are as presented in Table 1. Physical measures of turbofan engine measurements for fault diagnosis are listed in Table 2.

Table 3 summarizes the health parameters relevant to the turbofan engine in concern. The “Health State 1” refers to a large bypass turbofan engine that has completed 6000 flight cycles, where the “Health State 2” refers to a half of a degradation level of the “Health State 1”. The “Health State 2” is applied to the engine degradation level before sudden failures, whereas the “Health State 1” represents the engine degradation level after sudden failures.

TABLE 1
Design point parameters of turbofan engine

| Parameter | Symbol | Unit | Value |
|---|---|---|---|
| Mach Number | MN | — | 0.8 |
| Altitude | ALT | km | 11 |
| Inlet Air Flow | | kg/s | 222 |
| Rate | | | |
| Fuel Flow Rate | Wₜₙ | kg/s | 0.1876 |
| | W_{BFF} | | |
| Low Heating | LHV | MJ/kg | 118.429 |
| Value | | | |
| | EPR | — | 33.8 |
| | EBR | — | 9 |

TABLE 2
Physical measures of turbofan engine measurements

| SN | Measurement | Symbol |
|---|---|---|
| 1 | Ambient pressure | P₁ |
| 2 | Ambient temperature | T₁ |
| 3 | Fan bypass duct exit pressure | P₃₃ |
| 4 | Low-pressure compressor exit pressure | P₄ |
| 5 | Low-pressure compressor exit temperature | T₄ |
| 6 | High-pressure compressor exit pressure | P₅ |
| 7 | High-pressure compressor exit temperature | T₅ |
| 8 | High-pressure turbine inlet pressure | P₉ |
| 9 | High-pressure turbine inlet temperature | T₉ |
| 10 | Low-pressure turbine exit pressure | P₁₀ |
| 11 | Low-pressure turbine exit temperature | T₁₀ |
| 12 | Flight Mach number | MN |
| 13 | Low-pressure shaft rotational speed | N_{LP} |
| 14 | High-pressure shaft rotational speed | N_{HP} |
| 15 | Fuel flow rate | W_{Fuel} |

TABLE 3
Degradation factors of turbofan engine

| | | | | Health | Health |
|---|---|---|---|---|---|
| | | | Degradation | Condition | Condition |
| Component | Symbol | | Factor | 1 | 2 |
| Fan | X_{FAN} | X_{FAN.E} | Fan | −2.85% | −1.425% |
| | | | efficiency | | |
| | | | degradation | | |
| | | | factor | | |
| | | X_{FAN.F} | Fan flow | −3.65% | −1.805% |
| | | | capacity | | |
| | | | degradation | | |
| | | | factor | | |
| Low- | X_{LPC} | X_{LPC.E} | LPC | −2.61% | −1.305% |
| pressure | | | efficiency | | |
| compressor | | | degradation | | |
| | | | factor | | |
| | | X_{LPC.F} | LPC flow | −4.00% | −2.00% |
| | | | capacity | | |
| | | | degradation | | |
| | | | factor | | |
| High- | X_{HPC} | X_{HPC.E} | HPC | −9.40% | −4.70% |
| pressure | | | efficiency | | |
| compressor | | | degradation | | |
| | | | factor | | |
| | | X_{HPC.F} | HPC flow | −14.06% | −7.03% |
| | | | capacity | | |
| | | | degradation | | |
| | | | factor | | |
| High- | X_{HPT} | X_{HPT.E} | HPT | −3.81% | −1.905% |
| pressure | | | efficiency | | |
| turbine | | | degradation | | |
| | | | factor | | |
| | | X_{HPT.F} | HPT flow | +2.57% | +1.285% |
| | | | capacity | | |
| | | | degradation | | |
| | | | factor | | |
| Low- | X_{LPT} | X_{LPT.E} | LPT | +1.078% | −0.854% |
| pressure | | | efficiency | | |
| turbine | | | degradation | | |
| | | | factor | | |
| | X_{LPT.F} | | LPT flow | +0.4226% | +0.2113% |
| | | | capacity | | |
| | | | degradation | | |
| | | | factor | | |

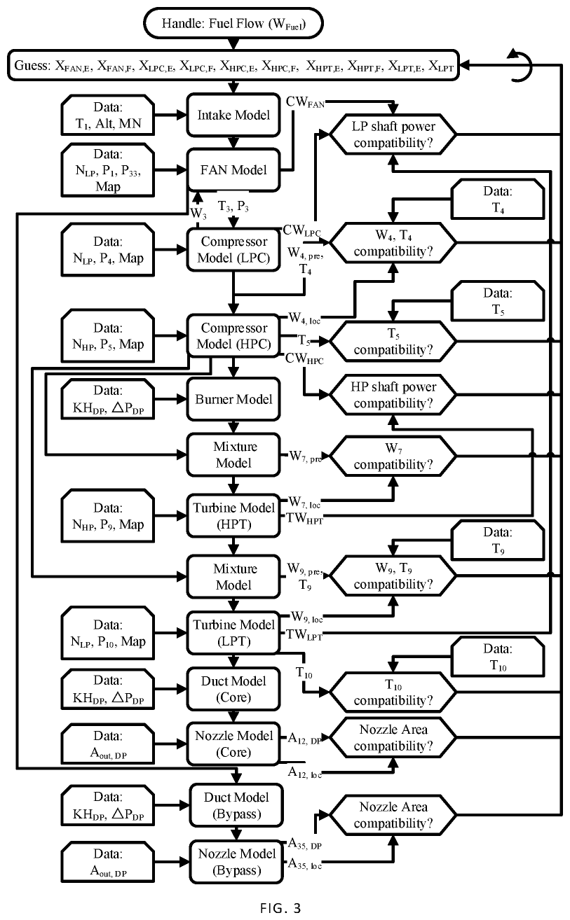

Iteration variables in the method proposed by the present disclosure are ten degradation factors listed in Table 3, and a fuel flow rate in FIG. 3 is the actual fuel supplied for the engines. The convergence criteria are listed in a hexagonal box on the right side in FIG. 3. The detailed process is explained as follows: The flight altitude, the Mach number, and the inlet conditions are known through on-wing measurements. Then, the fan inlet condition could be obtained by the intake model. It follows that the fan bypass pressure ratio could be calculated based on Equation (8), where P₃₃ is a gas path measurement. As the fan inlet condition, shaft speed, and bypass pressure ratio are known, the fan outlet temperature and pressure at both core and bypass could be determined through the fan model,

PR_{FAN,BP}=P₃₃/P₂ (8)

The LPC pressure ratio is obtained by Equation (9) where P₄ is a gas path measurement and P₃ could be determined from the fan model. Then, the LPC model calculation will follow as the pressure ratio, shaft speed, and inlet condition are known. It is worth noting that the core mass flow rate obtained in the LPC model is used to update the core flow and bypass flow rates in the fan model, which will also determine the bypass ratio. Moreover, the fan work is also updated according to the new bypass ratio,

PR_{LPC}=P₄/P₃ (9)

The HPC pressure ratio can be obtained by Equation (10) where P₅ and P₄ are gas path measurements. Then the HPC model could be used to calculate the outlet condition as the pressure ratio, shaft speed, and inlet condition are known,

PR_{HPC}=P₅/P₄ (10)

As the HPC outlet condition is known, the burner outlet condition could be calculated as the fuel flow rate is also known. The mixture model is applied to calculate the HPT inlet condition. The HPT pressure ratio could be obtained by (11) where P9 is gas path measurements and P7 could be known from the mixture model after the combustor,

PR_{HPT}=P₇/P₉ (11)

The LPT inlet condition could be obtained by the mixture after HPT. The LPT pressure ratio could be obtained by Equation (12) where P₉ and P₁₀ are gas path measurements. Finally, two sets of duct and nozzle are applied to calculate main flow and bypass flow exhaust condition,

PR_{LPT}=P₉/P₁₀ (12)

There are 11 convergence criteria in a diagnosis algorithm, which are represented in hexagonal boxes on the right side in FIG. 3. The convergence criteria may be classified into two categories: one set of convergence criteria is obtained from gas path measurements, including T₄, T₅, T₉, and T₁₀, and measurements and predicated values meet threshold conditions. The other set of convergence criteria is required to meet the flow balance, shaft power balance, and nozzle area design value at the design point. The shaft work of low-pressure and high-pressure shafts in the hexagonal boxes on the right side need to ensure conservation of the shaft work, that is, the turbine work is required to be equal to the compressor work plus the auxiliary work for power offtake all the time when a steady-state fault diagnosis model is employed. The surplus power under the transient condition is ignored in the prior art, so that diagnosis errors may be caused. Another assumption in the prior art is that the heat soakage effect and the lag response under the transient condition are ignored when the steady-state model is implemented. In such a condition, diagnostic accuracy may be compromised.

The present disclosure is intended to diagnose health conditions of the gas turbine engine with the time-series data under the steady-state and transient conditions. The dynamic effects cannot be ignored for the gas turbine engine exhibits a fast transient response characteristic.

The schematic diagram of the method proposed by the present disclosure is shown in

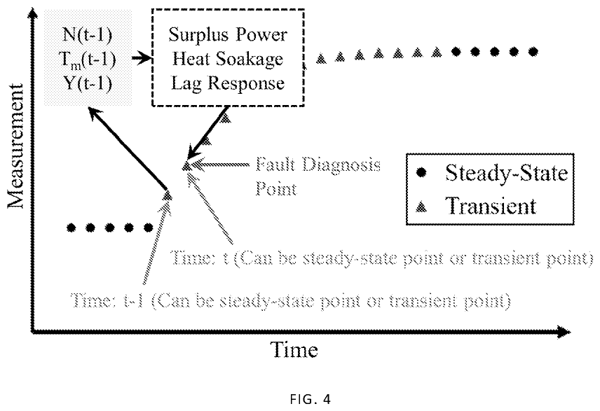

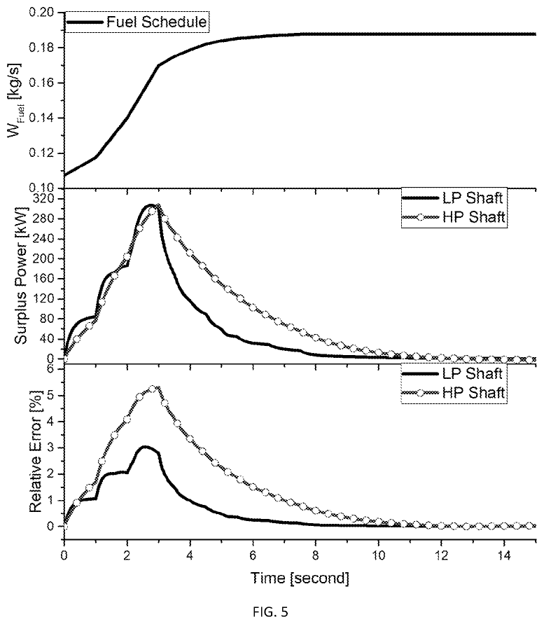

FIG. 4; the surplus power of the current moment is solved based on the rotational speeds at the previous moment and the current moment; the gas temperature and the engine metal temperature after considering the heat soakage effect are solved based on the engine metal temperature (Tₘ) at the previous moment; and the lag response of the sensors and the actuator are considered based on the first-order lag theory. Obviously, in the method proposed by the present disclosure, it is clear that the measurements are time-dependent in the proposed method, where the surplus power, transient heat transfer, and lag response are needed to be considered in consecutive time steps. This is highlighted in a dashed box in FIG. 4. Although the new method in FIG. 4 is illustrated by selecting two triangle points under the transient condition, the proposed new method is also applicable to the steady-state condition.

Specifically, the rotor speed at adjacent moments is obtained based on the continuous data to further obtain the rotor acceleration rate, and the surplus power at any moment may be obtained by the rotor acceleration rate, the rotational inertia and the rotational speed. When considering the surplus power, the turbine work is identically equal to the compressor work plus the surplus power and the auxiliary work for power offtake, so as to update the constraint conditions of fault diagnosis. A metal temperature at the next moment is calculated by utilizing a temperature measurement at the previous moment, so that the heat soakage under the transient condition may be characterized in the diagnosis model. Furthermore, the lag response reflecting the transient condition may be characterized through the first-order lag. Finally, as the measurement and diagnosis are successive, the sudden failure may also be diagnosed accurately at any time point of a transient maneuver.

To verify the estimation precision of a diagnosis method for steady-state and dynamic time-series faults of a gas turbine engine proposed by the present disclosure under steady-state and dynamic response conditions, four case studies for verifying algorithm performance under the steady-state and dynamic response conditions is designed. Meanwhile, to verify the necessity of the method of the present disclosure, a contrast test is carried out with the prior art. In order to obtain a direct comparison result, the same computer environment as the prior art is employed. A personal computer with Intel(R) i7 CPU @2.90 GHz and 16 GB RAM is used for evaluating the computation time of a diagnosis process for all case studies.

The objectives of these four examples are as follows:

Example I: This case study aims to evaluate the effectiveness of the benchmark diagnostic method when the engine gas path measurements represent dynamic operating conditions without consideration of heat soakage.

Example II: The measurements in this case study represent the dynamic performance with the effect of heat soakage included. This case study aims to investigate the effectiveness of the benchmark diagnostic method for diagnosing the health of the engine from transient measurements by taking into account the heat soakage phenomenon in order to set a baseline diagnostic data set that will be further used for comparing it with the proposed method.

Example III: This case study demonstrates and illustrates the proposed method's advantage compared to the baseline diagnostic results from Example II, which implemented the benchmark method.

Example IV: While the previous three examples tested the diagnostic results under constant fault levels during a dynamic maneuver, this example is designed to demonstrate the capability of the proposed method to deal with the sudden failure during the dynamic maneuver. The first three cases have a constant degradation level called “Operating Condition State 1” as shown in Table 3. In Case Study IV, we inject the degradation level denoted as “Health State 2” between [0-3) s and “Health State 1” between [3-15] s with the sudden failure initiated at the time mark of 3.0 s.

### Example I: Benchmark Method—Transient Measurements Without Considering Heat Soakage Effect

The benchmark method did not take into account surplus power in the fault diagnosis under dynamic conditions. This may be true as the focus of that study was a heavy-duty industrial gas turbine engine. Due to its large shaft inertia, the transient maneuver for heavy-duty gas turbine engines is relatively slower than other gas turbines (i.e., aero-derivative engines and turbofans). However, such an assumption will compromise the diagnostic performance of other gas turbines.

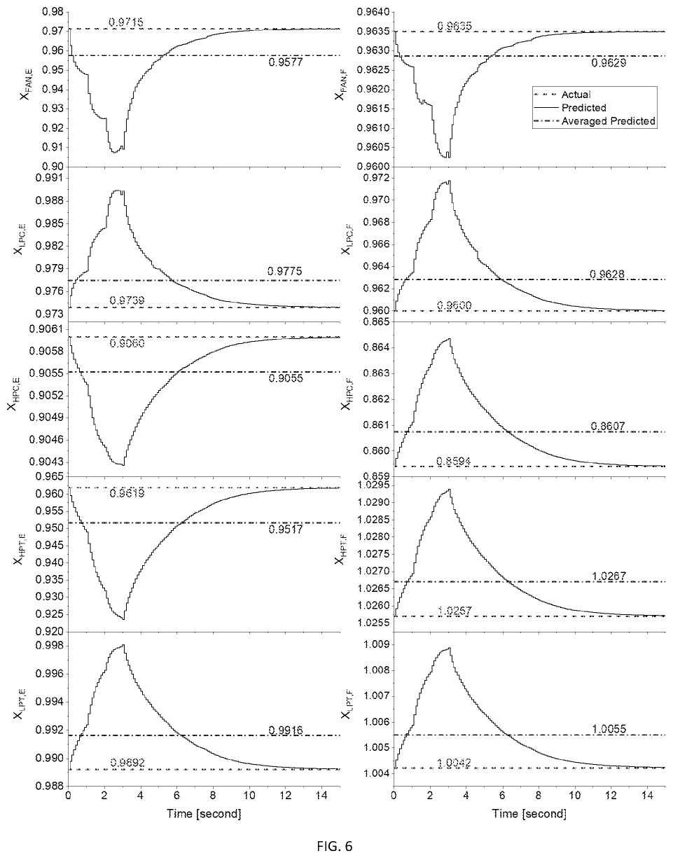

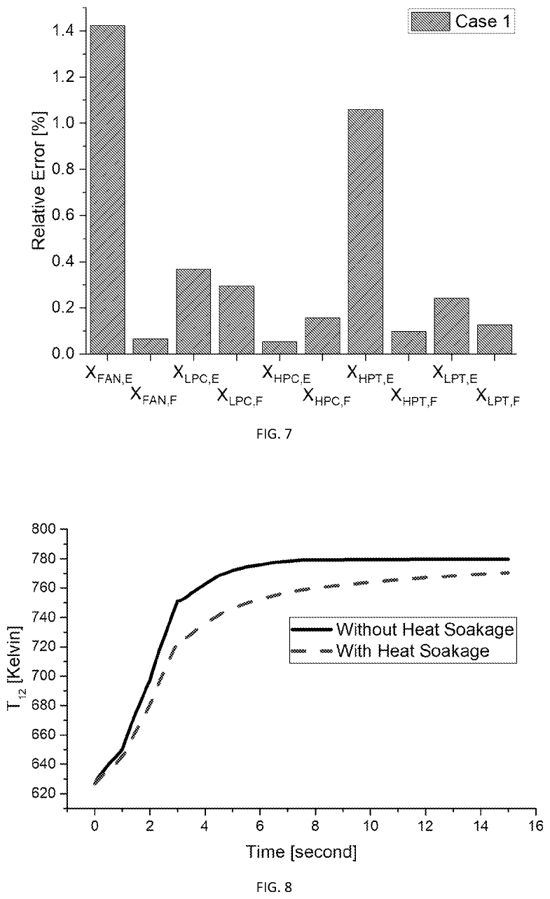

FIG. 5 (top) demonstrates an acceleration fuel schedule with a 0.1 s time step during a dynamic maneuver for the turbofan engine. The power balance among all shafts will not be satisfied during the dynamic maneuver. As shown in FIG. 5 (middle), the maximum surplus power obtained from the power imbalance between the compressor and the turbine is close to 320 kW during the maneuver for both low-pressure and high-pressure shafts. The maximum relative error between the compressor work and the turbine work is 5.3% and 3.0% for the low-pressure and high-pressure shafts in FIG. 5 (bottom), respectively. Therefore, if the surplus power is ignored, the relative error will propagate to the diagnostic results. It can be seen therefrom that the larger the surplus power is, the less accurate the diagnostic results are. The average computation time for diagnosis with the benchmark method is 0.2071 s. FIG. 6 shows the diagnostic results based on the benchmark method. It is apparent from this figure that the surplus power impacts the accuracy of the diagnosis. The error of the diagnosis keeps increasing 16 until approximately the 3 s mark, where the maximum prediction error is observed. Then, the prediction error of health parameters decreases as the surplus power falls off. In such a condition, the benchmark method will lead to fluctuation of the diagnostic results and may set a false alarm of sudden engine degradation. Moreover, the faster the variation of the fuel flow rate is, the larger the surplus power and the bigger the prediction errors are going to be. The average prediction error of all 10 health parameters during the dynamic maneuver is shown in FIG. 7. Although the average maximum prediction error of 10 health parameters hovers at about 1.5%, the maximum prediction error during the dynamic operation is 6.5852% % at 2.5 s for X_{FAN,E}. Such a prediction error may lead to inaccurate diagnosis.

In summary, the benchmark method could be beneficial if the surplus power is negligible. This typically happens when there is a slow variation of fuel flow rate with respect to time during a transient maneuver. In other cases, the benchmark method will significantly fluctuate its diagnostic results. Consequentially, the benchmark method cannot monitor the engine health state in real-time when each set of measurements is recorded. Thus, such a method is not capable of monitoring the sudden engine failure that a bird strike may cause.

### Example II: Benchmark Method—Dynamic Measurements by Considering Heat Soakage

Under dynamic operating conditions, the gas turbine engine is not only facing power imbalance among shafts but also experiences heat transfer between gas and engine components. FIG. 8 shows the impact of the heat soakage effect on exhaust gas temperature with time during the dynamic maneuver with and without considering the heat soakage effect. It is evident that the heat soakage effect impacts the gas path measurement of the exhaust gas temperature by delaying its increase in comparison with the case where the heat soakage effect is ignored, as shown in FIG. 8. If the engine is faced with a slam dynamic maneuver, the predicted engine health parameters are likely to be affected.

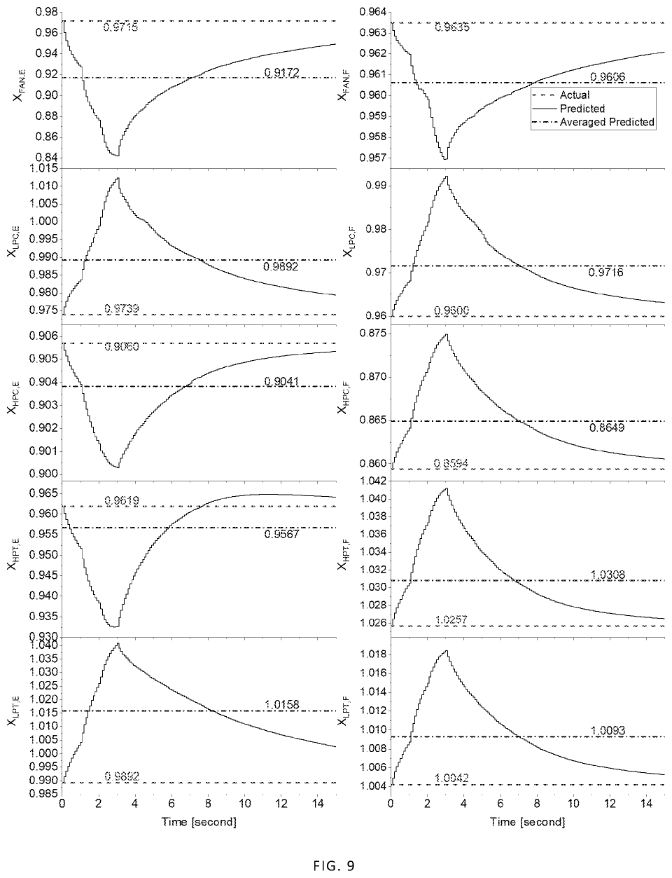

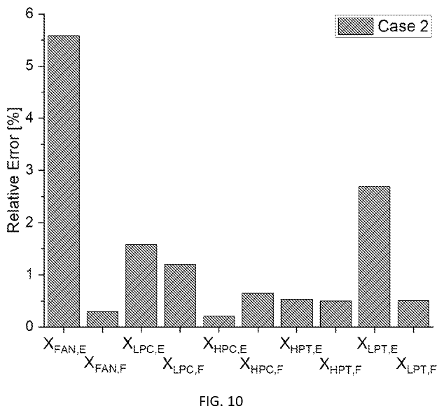

The average computation time for diagnosis is 0.2083 s during the 15 s maneuver, where the benchmark method has been implemented. It can be seen from FIG. 9 that the estimated degradation factors have a relatively higher deviation from the actual health state when compared with Example I. Apart from the HPT efficiency degradation factor, the heat soakage effect will increase the prediction error when considering the heat soakage effect in dynamic measurements. The surplus power will lead to over-prediction of the HPT efficiency degradation, while the heat soakage effect will over-predict the HPT efficiency degradation. FIG. 10 provides the summary of the average prediction error for 10 health parameters. The maximum average error of the benchmark method has increased from 1.4240% in Example Ito 5.5853% in Example II when the dynamic measurements consider the heat soakage effect. Moreover, the maximum error during the entire dynamic maneuver is 13.2919% in Example II at 3.0 s for X_{FAN, E}. The consideration of heat soakage effect in the engine measurements will delay the prediction of the maximum degradation for all 10 degradation factors. Ignoring the heat soakage effect during dynamic diagnosis will impact the prediction accuracy under dynamic conditions.

The results show that using dynamic measurements in a steady-state fault diagnosis system will have noticeable prediction errors under dynamic operating conditions. Moreover, the shift of diagnostic results is possible to raise a false alarm. If the diagnosis system dispatches frequent false alarms, the fault diagnosis program's confidence will be significantly compromised from an operation and maintenance perspective.

### Example III: Method Proposed by the Present Disclosure—Monitoring of Constant Health States During Dynamic Maneuver

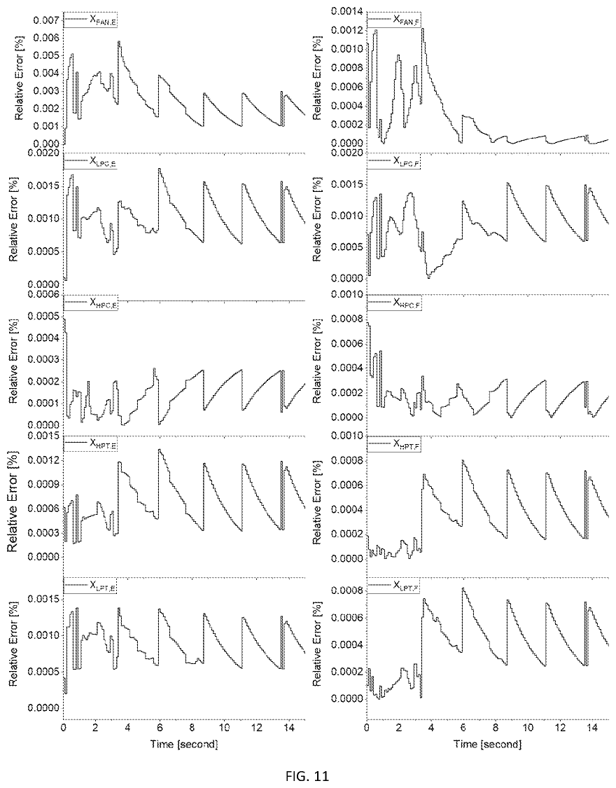

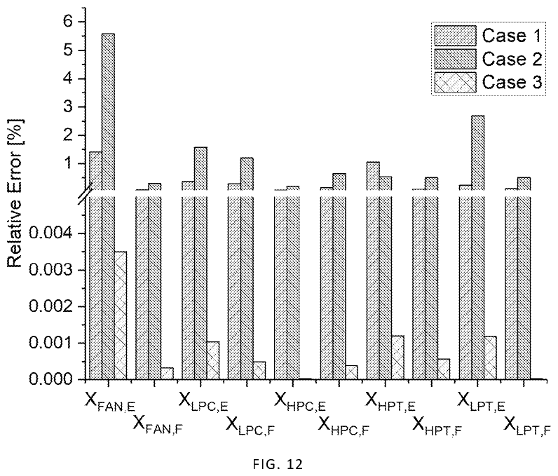

In this example, the method proposed by the present disclosure is used for continuous fault diagnosis during the dynamic maneuver, and the heat soakage effect is considered in the continuous diagnosis of gas path faults at any moment in the transient maneuver of the gas turbine engine. FIG. 11 shows relative errors of 10 degradation factors during the dynamic maneuver. It can be noted that the maximum error in FIG. 11 is 0.0066% at 11.4 s for X_{FAN,E}. Comparing the results in three examples (FIG. 12) reveals that the method proposed by the present disclosure can estimate the health parameters with greater precision than the benchmark method. Table 4 summarizes the diagnostic results for all examples. The computation time of Example III is 0.1619 s which is slightly better than that of Example II. This is because the maximum allowed iteration steps terminate the diagnostic process; rather than the convergence threshold when affected by surplus power, heat soakage effect, and lag effect during the dynamic maneuver. The average diagnostic error by the method proposed by the present disclosure is 0.0009% which is superior to the benchmark method (1.3754% in Example II). Moreover, the maximum error during the entire dynamic maneuver is 13.2919% and 0.0066% in Examples II and III, respectively. The results show that the proposed time-series fault diagnosis method is superior to the benchmark method in both computation time and prediction accuracy aspects.

TABLE 4
Summary of three diagnosis cases

| | | | Example | Example | Example |
|---|---|---|---|---|---|
| Parameter | Symbol | Unit | I | II | III |
| Average Run Time | RT | s | 0.2071 | 0.2083 | 0.1619 |
| Average Error | AE | % | 0.3887 | 1.3754 | 0.0009 |
| Maximum Error | ME | % | 6.5852 | 13.2919 | 0.0066 |

### Example IV: Method Proposed by the Present Disclosure—Sudden Failure During Dynamic Maneuver

The aero-engine may be faced with foreign object damage like bird strikes during flight.

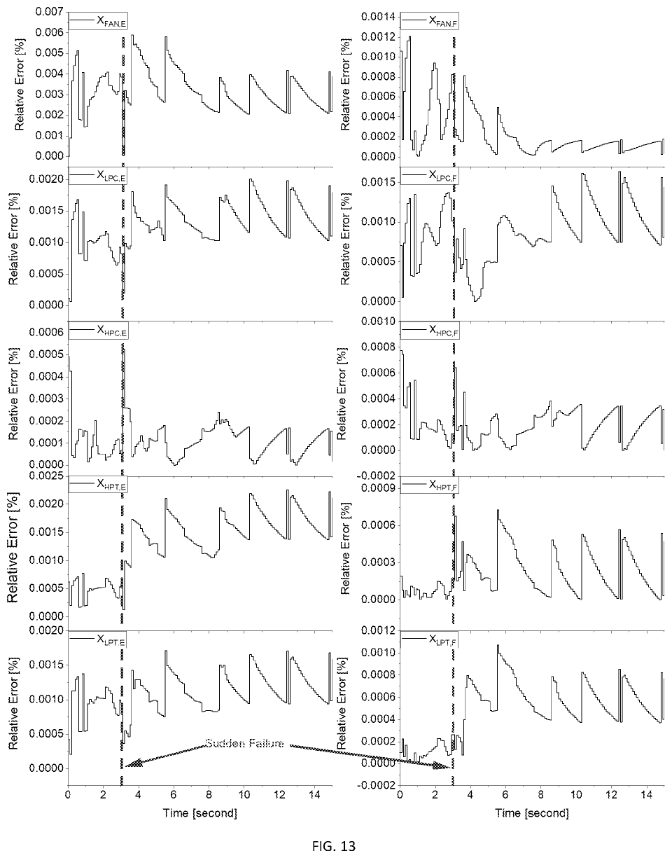

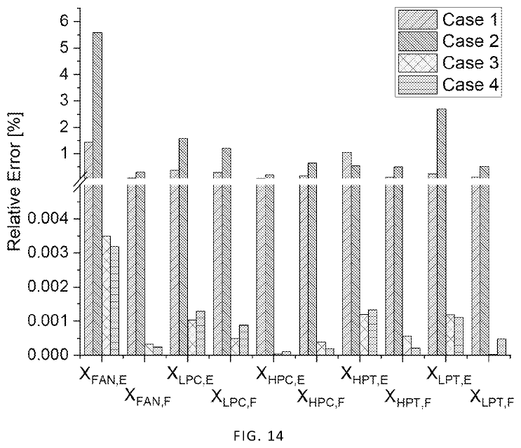

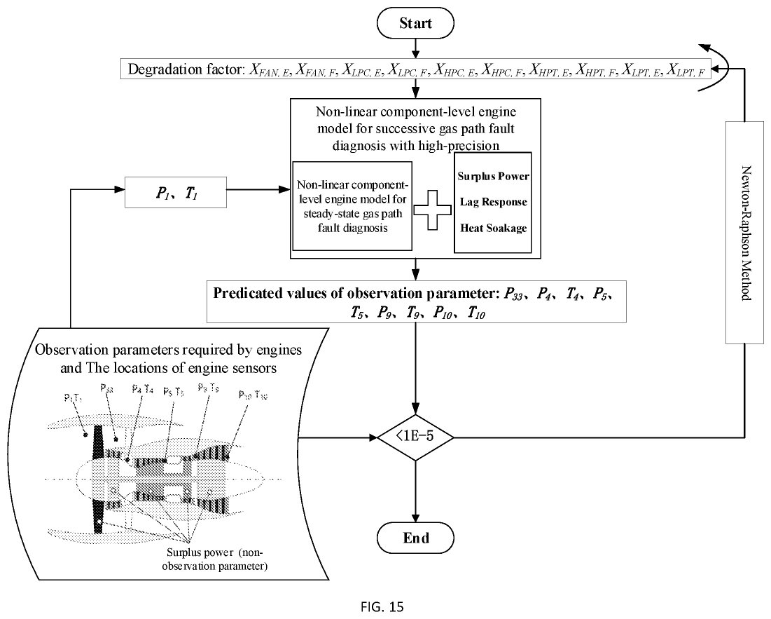

In such a condition, sudden degradation may happen during the flight. Moreover, the bird strike is more likely to occur during the take-off and landing processes when the engine runs under a dynamic or quasi-steady-state condition. Hence, it is necessary to verify the capability of the method proposed by the present disclosure under a sudden damage under the dynamic conditions in real time. The sudden failure is assumed to happen at the 3.0 s mark during the dynamic maneuver in FIG. 5 (top). The operating condition state is suddenly changed from “Operating Condition State 2” to “Operating Condition State 1”, as shown in Table 3. FIG. 13 presents the relative error of diagnostic results obtained from this method under the dynamic conditions. It can be seen from FIG. 13 that the method proposed by the present disclosure can capture the sudden failure with high prediction accuracy in real time. FIG. 14 compares the results of 10 health parameters among all 4 examples. The maximum relative error of all 10 degradation factors is less than 0.004%. It is evident that the relative error of all health parameters with the sudden failure in Example IV is similar to that of Example III.

Table 5 presents the diagnostic results of all four examples. The average computation time of Example IV is only 0.15820 s which amplifies the suitability of this method for real-time diagnosis. It is worth noting that the computation time of Example IV is similar to Example III. The sudden failure does not affect the computational efficiency of this method. From the perspective of diagnostic accuracy, the average and maximum errors for all 10 health parameters during the dynamic maneuver are 0.0009% and 0.0059%, respectively. The maximum error is observed at 3.6 s for X_{FAN,E} and the sudden failure is taking place at 3.0 s, which means that the method proposed by the present disclosure is not compromised when dealing with the sudden failure. The average and maximum errors of Example IV are similar to those of Example III. The sudden failure under the dynamic conditions does not affect diagnostic accuracy either.

TABLE 5
Summary of four diagnosis cases

| | | | Exam- | Exam- | Exam- | Exam- |
|---|---|---|---|---|---|---|
| Parameter | Symbol | Unit | ple I | ple II | ple III | ple IV |
| Average | RT | s | 0.2071 | 0.2083 | 0.1619 | 0.1582 |
| Run | | | | | | |
| Time | | | | | | |
| Average | AE | % | 0.3887 | 1.3754 | 0.0009 | 0.0009 |
| Error | | | | | | |
| Maximum | ME | % | 6.5852 | 13.2919 | 0.0066 | 0.0059 |
| Error | | | | | | |

The results show that this method is capable of diagnosing the engine health state with time-series data under both steady-state and dynamic conditions in real time, and capable of accurately predicating even when there are sudden failures under dynamic conditions.

Further studies are suggested to integrate this method with an aircraft model and a gas turbine starting model to track the engine health state from engine start until engine shut down during the whole aircraft mission, so as to provide true real-time fault diagnosis to play a role of possibly improving the reliability, availability, and safety of the gas turbine engine.

Although the examples of the present disclosure have been illustrated and described above, it can be understood that the above examples are exemplary and cannot be construed as a limitation to the present disclosure. A person of ordinary skill in the art may make various changes, modifications, replacements and variations to the above examples without departing from the principle and objective of the present disclosure.

1. A successive gas path fault diagnosis method with high precision for gas turbine engines, the gas path faults comprising steady-state and transient path faults, wherein the method comprises the following steps:
Step 1: establishing an engine nonlinear component-level model;
Step 2: capturing the dynamic effects of a transient maneuver in the engine nonlinear component-level model;
Step 3: outputting an estimated value of an engine observation parameter by the engine nonlinear component-level model;
Step 4: acquiring a measurement of the engine observation parameter through sensors; and
Step 5: updating a degradation factor X through a solver, thereby minimizing difference between a predicated value Z_{predict} of the observation parameter outputted by a fault diagnosis model and an actual measurement Z_{Actual} of the engine observation parameter obtained by the sensors on-wing,
Z_{predict}−Z_{Actual}=f(X) (1)
where X is a degradation factor for simulating the performance degradation of engine components.

2. The successive gas path fault diagnosis method with high precision for gas turbine engines according to claim 1, wherein in step 1, a Newton-Raphson iterative method is used for establishing the engine nonlinear component-level model.

3. The successive gas path fault diagnosis method with high precision for gas turbine engines according to claim 1, wherein in step 2, a method for capturing dynamic effects of an engine transient maneuver in the engine nonlinear component-level model comprises:
(1) obtaining a rotor speed at adjacent moments based on continuous data to further obtain a rotor acceleration rate, and obtaining surplus power at any moment by the rotor acceleration rate, a rotational inertia and a rotational speed, wherein when considering the surplus power, turbine work is identically equal to compressor work plus the surplus power and auxiliary work for power offtake, so as to update constraint conditions of fault diagnosis;
(2) obtaining a gas temperature and an engine metal temperature after considering a heat soakage effect based on the engine metal temperature Tₘ at the previous moment; and
(3) considering a lag response of the sensors and an actuator based on a first-order lag theory.

4. The successive gas path fault diagnosis method with high precision for gas turbine engines according to claim 3, wherein method steps for considering the surplus power are as follows:
as an engine shaft rotational speed is monitored in time-series, deriving the rotor acceleration rate through the deviation of the shaft rotational speed in finite time by Equation (1),
$$\frac{dN}{dt} = \frac{N ( t + Δ t ) - N ( t )}{Δ t} , \qquad ( 1 )$$
in such a condition, calculating the surplus power SP by Equation (2) by the rotor acceleration rate, the shaft rotational speed and a shaft inertia
$$SP = \frac{4 {π}^{2}}{3600} \cdot I \cdot N \cdot \frac{dN}{dt} , \qquad ( 2 )$$
then, obtaining shaft power balance among all shafts by Equation (3), the equation being tenable for both steady-state and transient conditions, where SP is zero under the steady-state condition; and therefore, the conditions of the shaft power balance is met when the surplus power is considered for both the steady-state and transient conditions,
TW=SP+CW+AW (3),
where TW is turbine work, CW is compressor work, and AW is auxiliary work for power offtake.

5. The successive gas path fault diagnosis method with high precision for gas turbine engines according to claim 3, wherein a specific method step for considering a heat soakage effect is as follows:
obtaining heat transfer between gas flow and an engine metal by Equation (4),
Q=Uₕₜ·Aₕₜ(T_{g}−Tₘ)·(e^{-Δt/τ}−1) (5)
where Q is a heat rate, Uₕₜ is a heat transfer coefficient, Aₕₜ is an effective contact surface, T_{g} is a gas temperature in the current step, without considering the heat soakage effect, Tₘ is a body temperature in the previous step, Δt is a time step, and τ is a time constant.

6. The successive gas path fault diagnosis method with high precision for gas turbine engines according to claim 3, wherein a specific method step for considering a lag response is as follows:
representing a lag phenomenon existing in the engine sensors and the actuator during transient operation by employing a first-order lag,
$$\frac{Y ( s )}{B ( s )} = \frac{1}{τ \cdot s + 1} , \qquad ( 5 )$$
where τ is a time constant, Y(s) is an input value with delay, and B(s) is an input value without delay.

7. The successive gas path fault diagnosis method with high precision for gas turbine engines according to claim 1, wherein in step 4, the sensors are located on wings.

8. The successive gas path fault diagnosis method with high precision for gas turbine engines according to claim 1, wherein in step 5, the Newton-Raphson method is selected to establish an iterative solver.

9. The successive gas path fault diagnosis method with high precision for gas turbine engines according to claim 1, wherein in step 5, performance simulation and fault diagnosis processes are called in the same iterative loop:
(1) characterizing the degree of degradation of each characteristic parameter in the components, i.e. the degradation factor X, by using the ratio of component characteristic parameters after degradation to component characteristic parameters in a health state;
(2) obtaining a flight altitude, a Mach number, and inlet conditions of a fan through the sensors in step 4;
(3) in the engine nonlinear component-level model of step 1, classifying convergence criteria into two categories according to an engine principle and an thermodynamics relationship of all the components: obtaining one set of convergence criteria from gas path measurements, comprising T₄, T₅, T₉, and T₁₀, and measurements and predicated values meeting threshold conditions; and the other set of convergence criteria being required to meet flow balance, shaft power balance, and a nozzle area design value at a design point; and
(4) in an iterative process, selecting a root mean square error RAISE defined by Equation (6) to evaluate the convergence with a threshold of 1E-5:
$$R M S E = \frac{{Z}_{Predict} - {Z}_{Actual}}{{Z}_{Actual}} . \qquad ( 6 )$$
